(19) United States
(12) Patent Application Publication
(10) Pub. No.: US 2008/0099520 A1
(43) Pub. Date: May 1, 2008

(54) TRUCK BED BOX

(76) Inventor: Charlie B. Mitchell JR., Lavergne, TN (US)

Correspondence Address: W. EDWARD RAMAGE, COMMERCE CENTER SUITE 1000, 211 COMMERCE ST, NASHVILLE, TN, 37201, US

(21) Appl. No.: 11/925,412

(22) Filed: Oct. 26, 2007

Related U.S. Application Data
(60) Provisional application No. 60/863,168, filed on Oct. 27, 2006.

(51) Int. Cl. B60R 9/00

(52) U.S. Cl. 224/404

(57) ABSTRACT

A box or container of an appropriate size and configuration to fit within the bed of a truck in whole or in part. The box may take up a substantial portion of the area of the bed, possibly one-half and up to the entire area of the bed, essentially creating a new floor in the truck bed. The box dimensions and configurations may vary to fit within a variety of truck beds for different makes and models of trucks, and may include appropriately-sized side spaces along the side for trucks where wheel wells extend into the bed. The box may have a single compartment or multiple compartments inside. Dividers may be used in some embodiments to allow the user to adjust the number and size of compartments. One or more lids may provide access to the interior compartments.

This application claims benefit of U.S. Provisional App. No. 60/863,168, filed Oct. 27, 2006, by Charlie B. Mitchell, Jr. and is entitled to that filing date for priority. The entire disclosure, specification, attachments, and drawings of the above application are incorporated herein by specific reference.

### FIELD OF INVENTION

This invention relates to a box or container suitable for use with motor vehicles. More particularly, the present invention relates to a box or container that fits within the bed of a truck.

### BACKGROUND OF INVENTION

A variety of boxes or containers that fit within the beds of pickup trucks are well-known in the art. The typical example of such a box is suspended from the sides of the truck bed behind the cab, and extends partially or fully down to the bottom of the bed. Containers with this design take up substantial space within the bed, and reduce the amount of usable area. Moreover, a large portion of the space inside deeper boxes goes unused.

Accordingly, what is needed is a box that fits within the bed of a truck, maximizes the utilization of space within the box, while also maximizing the usable area of the truck bed.

### SUMMARY OF THE INVENTION

In one exemplary embodiment, the inventor comprises a box or container of an appropriate size and configuration to fit within the bed of a truck in whole or in part. The box may take up a substantial portion of the area of the bed, possibly one-half and up to the entire area of the bed, essentially creating a new floor in the truck bed. The box dimensions and configurations may vary to fit within a variety of truck beds for different makes and models of trucks, and may include appropriately-sized side spaces along the side for trucks where wheel wells extend into the bed. In some embodiments, the height (or depth) of the box may be high or deep enough so that the side spaces may be covered by the top of the box.

The box may have a single compartment or multiple compartments inside. Dividers may be used in some embodiments to allow the user to adjust the number and size of compartments. The compartments may be used for any purpose desired, such as, but not limited to, storing tools, plans, hunting equipment, athletic equipment, and the like. One or more lids may provide access to the interior compartments.

### BRIEF DESCRIPTION OF THE DRAWINGS

FIG. 1 shows a top view of a truck bed box in accordance with one exemplary embodiment of the present invention.

FIG. 2 shows a side view of a stylized pickup truck with a truck bed box in accordance with an exemplary embodiment of the present invention.

FIG. 3 shows a perspective view of a truck bed box in accordance with an exemplary embodiment of the present invention.

FIGS. 4 through 7 show top views of alternative lid configurations of a truck bed box in accordance with exemplary embodiments of the present invention.

FIG. 8 shows a top view of alternative lid configurations and different lengths of a truck bed box in accordance with exemplary embodiments of the present invention.

FIG. 9 shows a perspective exploded view of a truck bed box with wings and an end cap.

FIG. 10 shows a top view of a truck bed box with wings and an end cap.

FIG. 11 shows cross-sectional views of the truck bed box of FIG. 10.

FIG. 12 shows detailed cross-sectional views of the truck bed box of FIG. 11.

### DETAILED DESCRIPTION OF EXEMPLARY EMBODIMENTS

Referring now to the numerous figures, wherein like references identify like elements of the invention, the figures illustrate several exemplary embodiments of the invention comprising a box or container 10 of an appropriate size and configuration to fit within the bed of a truck 2 in whole or in part (dimensions mentioned in the disclosure or shown in the figures are merely exemplary figures for a particular embodiment; the dimensions of the invention can vary from those described and shown).

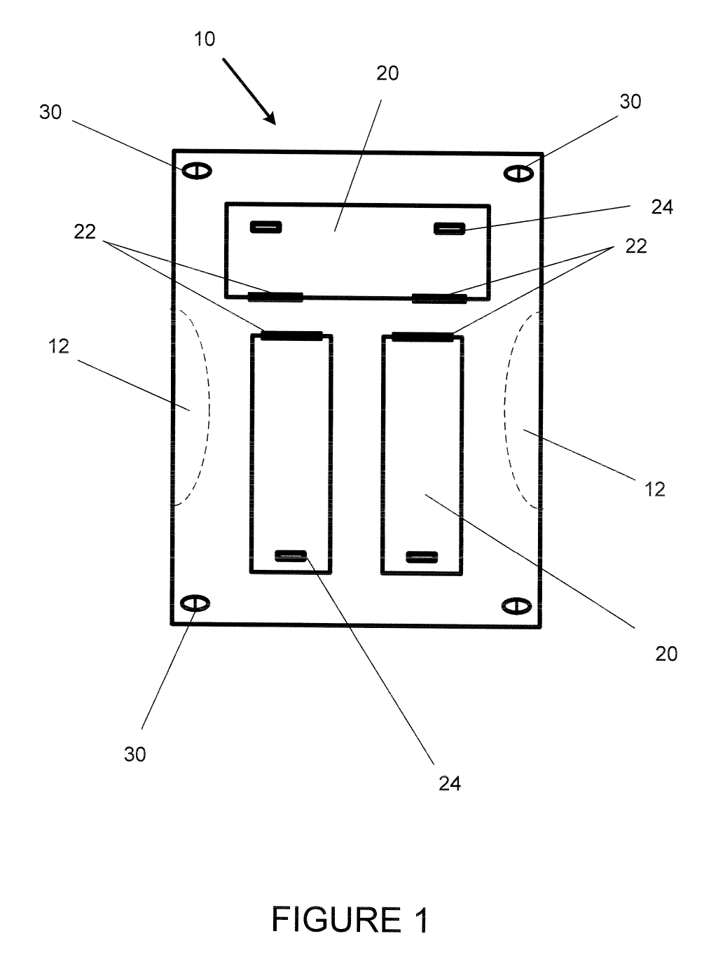

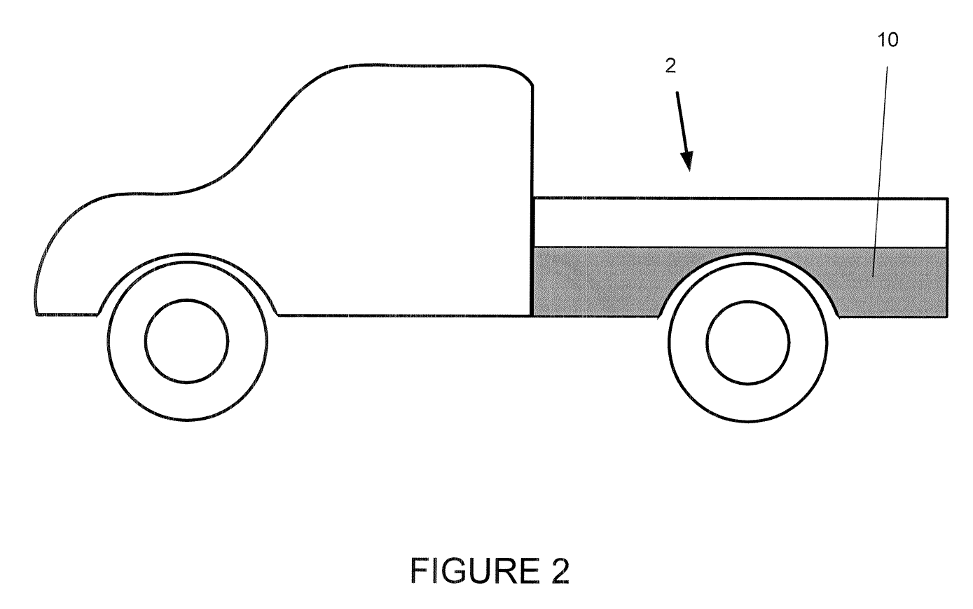

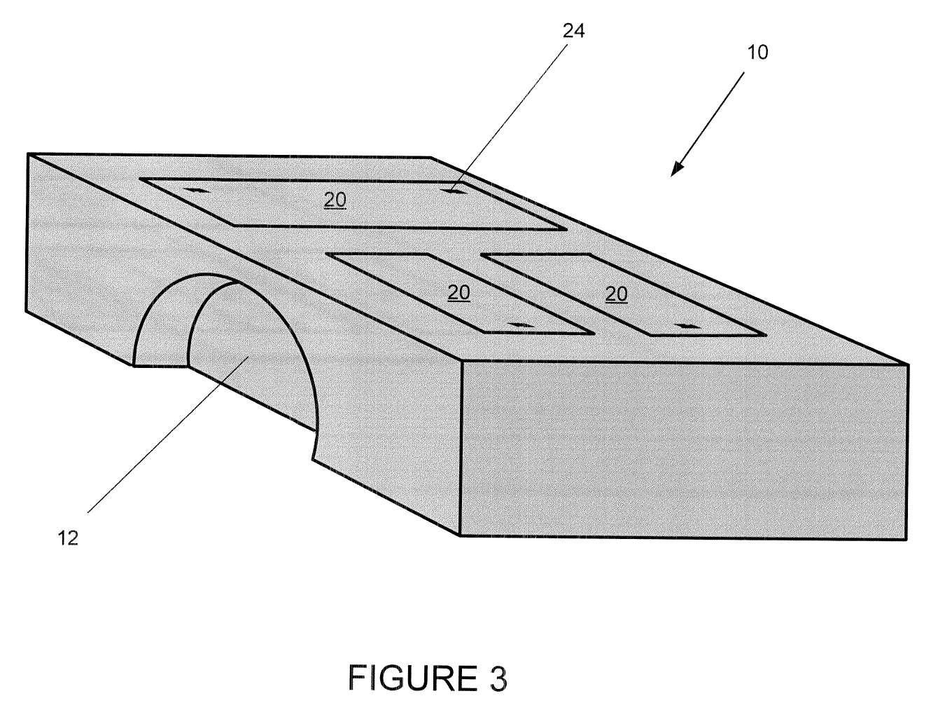

In one exemplary embodiment, as shown in FIGS. 1 and 2, the box or container 10 rests upon the bottom of the truck bed 2, and may be fastened thereto. The box may take up a substantial portion of the area of the bed, possibly one-half and up to the entire area of the bed (as shown in FIG. 1), essentially creating a new floor in the truck bed. The box dimensions and configurations may vary to fit within a variety of truck beds for different makes and models of trucks, and may include appropriately-sized side spaces 12 along the side for trucks where wheel wells extend into the bed. In some embodiments, the height (or depth) of the box 10 may be high or deep enough so that the side spaces 12 may be covered by the top of the box, as shown in FIGS. 1 and 3. In other embodiments, the box 10 may not extend so high, and the side spaces 12 may be open at the top.

The box 12 may have a single compartment or multiple compartments inside. Dividers may be used in some embodiments to allow the user to adjust the number and size of compartments. The compartments may be used for any purpose desired, such as, but not limited to, storing tools, plans, hunting equipment, athletic equipment, and the like.

Similarly, the box may have a single or multiple lids 20. The lids may correspond to particular compartments, although this is not necessarily so in all embodiments. For example, a single lid 20 can provide access to multiple compartments. Similarly, multiple lids 20 can provide access to the same compartment. In one exemplary embodiment, the lids have one or more hinges 22 at one end or side and one or more handles 24 to help in lifting the lid 20. Handles 24 and hinges 22 may be recessed (for “smooth” applications) or extruded. Handles may be used as tie-downs in either form. Separate tie-downs 30 may also be provided in a variety of locations. Lids 20 may be fitted with locks 56, hinges, holding stays, rods, or other features known in the art for similar lids.

While the box 10 may be any depth, in one exemplary embodiment, the depth of the box is sized so as to be approximately 50% of the total bed depth. Accordingly, in configurations where the box takes up the entire area of the truck bed, the entire bed of the truck may be used, albeit at half depth, with the top of the box acting as the floor of the bed. Whatever the depth, the box allows the truck user to use the box for storage while the top of the box serves as a substitute bed floor so that the user can park and transport 4-wheelers, coolers, decoys, dog boxes, air compressor, boats, and the like, on top of the box.

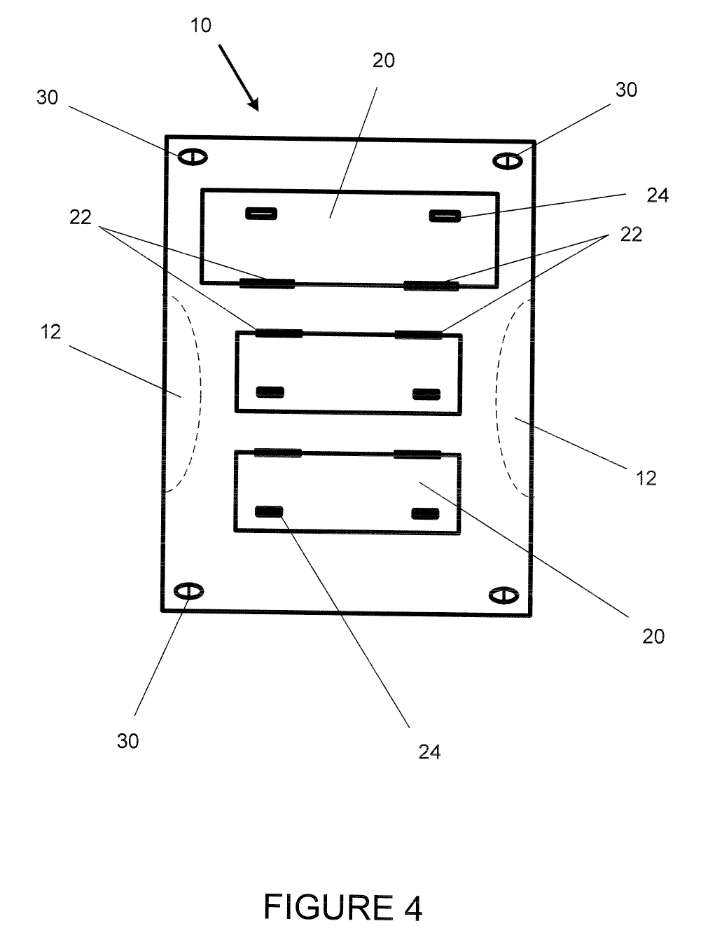

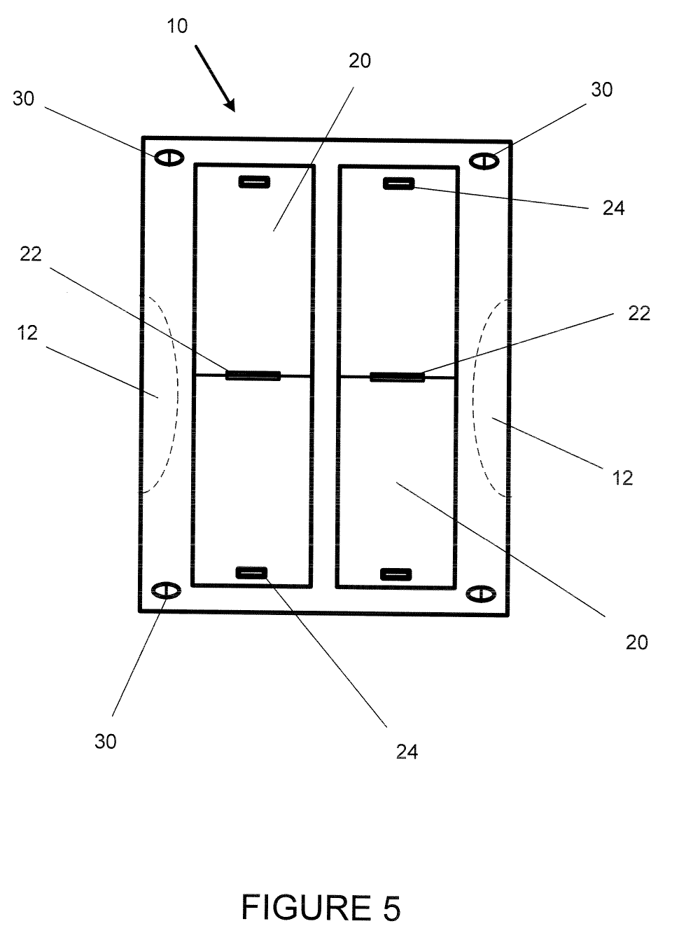

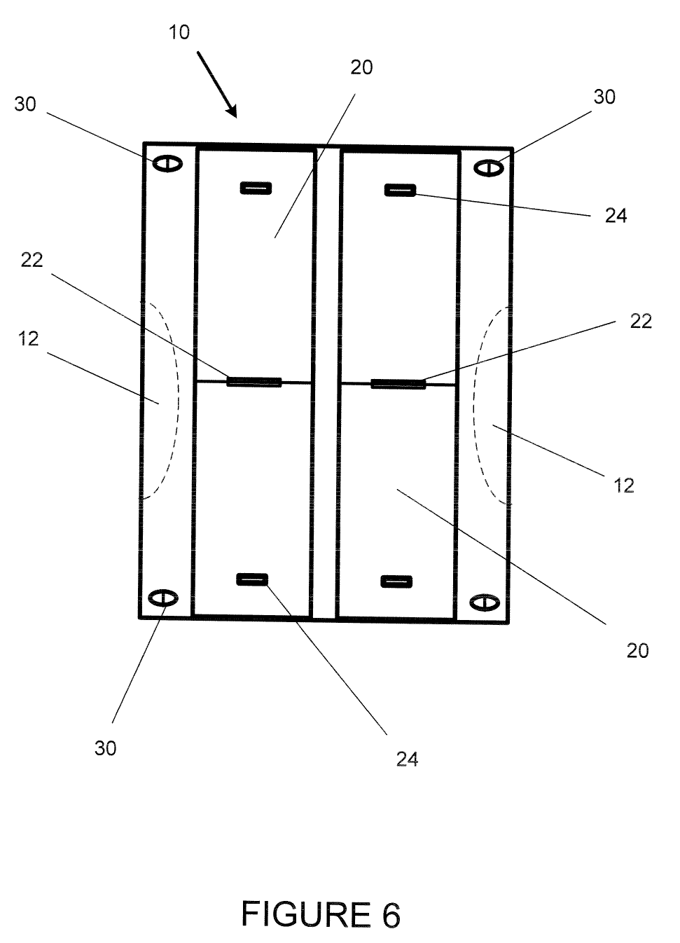

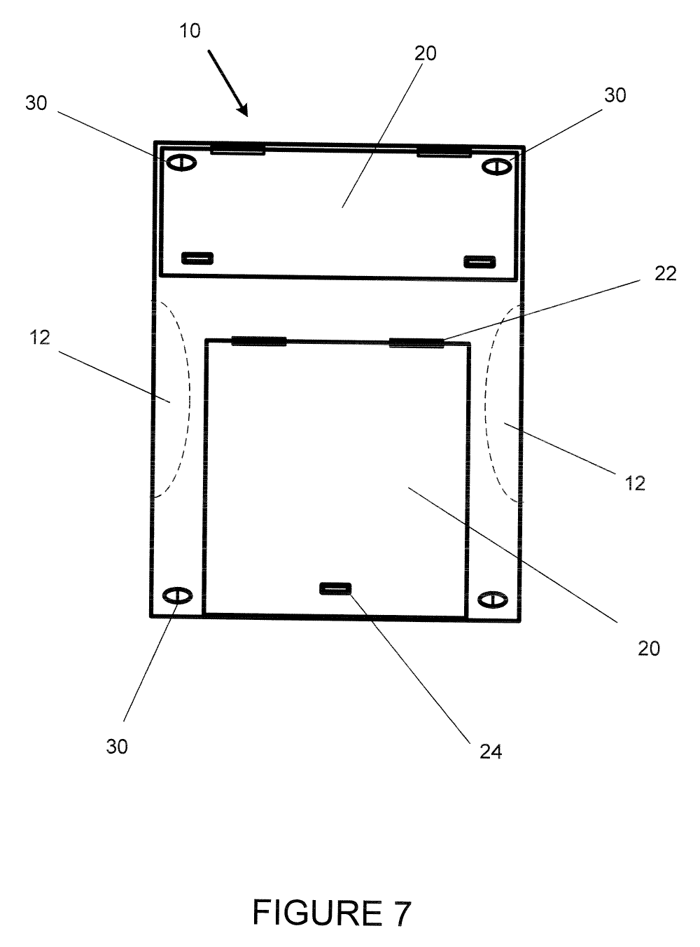

FIGS. 4 through 7 show several various exemplary embodiments comprising different lid and/or compartment layouts and configurations.

The dimensions of the box will vary depending on the type of truck with which it is to be used, and the extent of the truck bed to be used. In one exemplary embodiment of a “full bed” box, the box is 79 inches long, 62 inches wide, and 10 inches deep, with the wheel-well side spaces extending inwards up to 7 inches. The size of the lids can vary greatly, as well. In one exemplary embodiment comprising three lids on a “full bed” box, one lid may be 46 inches long and 18 inches wide, with the remaining two lids 43 or 38 inches long and 15 inches wide. In another embodiment with two lids, one lid may be approximately 62 inches wide (substantially the width of the box) and 31 inches long, while the second lid may be approximately 42 inches long and 38 inches wide.

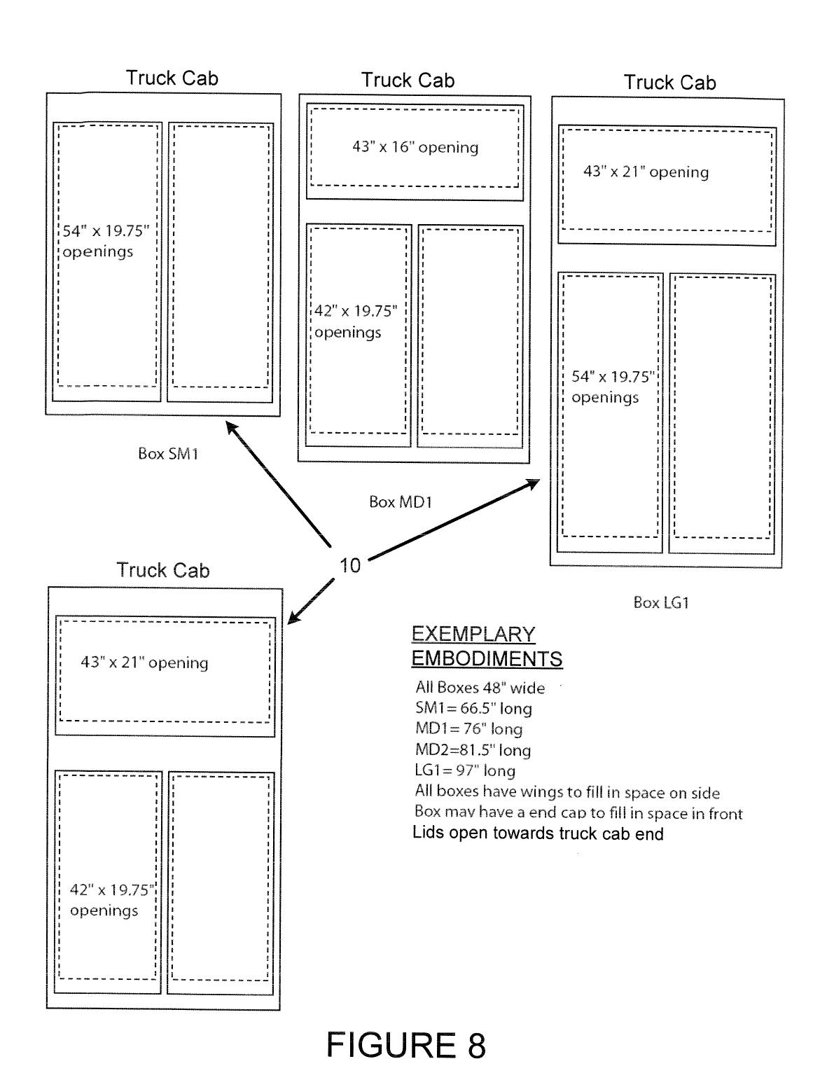

FIG. 8 shows four different lengths of box with different lid configurations (the openings to the interior of the box are indicated by broken lines). The length may be sized to fit within the bed of a particular size of truck or truck bed, or may be sized to cover only a portion of a larger truck bed.

Accordingly, in several exemplary embodiments designed to fit particular truck bed sizes popularly sold today, the box may be 48 inches wide, and 66.5 inches, 76 inches, 81.5 inches, or 97 inches long. Opening sizes may be as indicated in FIG. 8, although the opening sizes may vary.

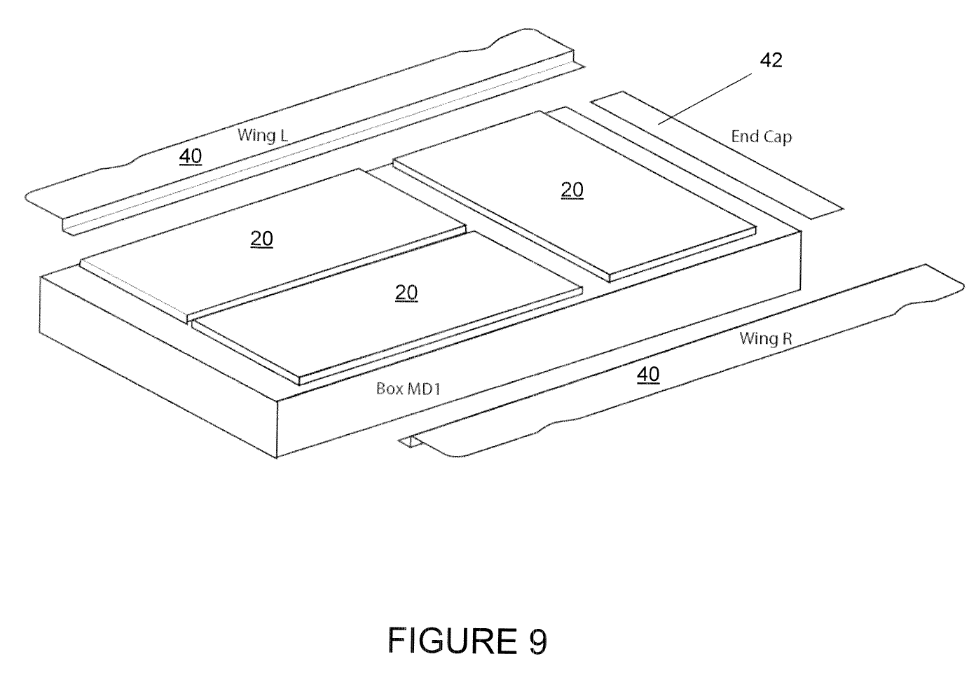

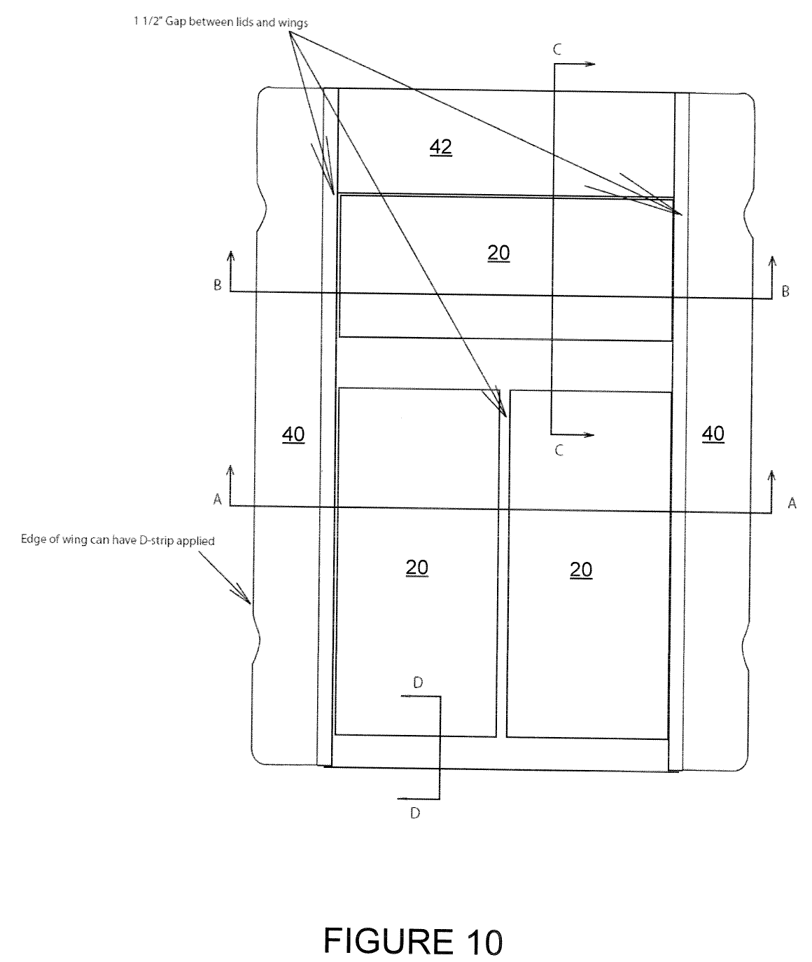

As shown in FIGS. 9 and 10, wings 40 may be used on one or both sides of the box to fill in the space on the side between the box and the side wall of the truck bed. Similarly, an end cap 42 may be used to fill in the space at one end of the box. A trim kit comprising wings and an end cap of suitable dimension may be provided with each box so as to ensure a fit with various trucks of appropriate sizes.

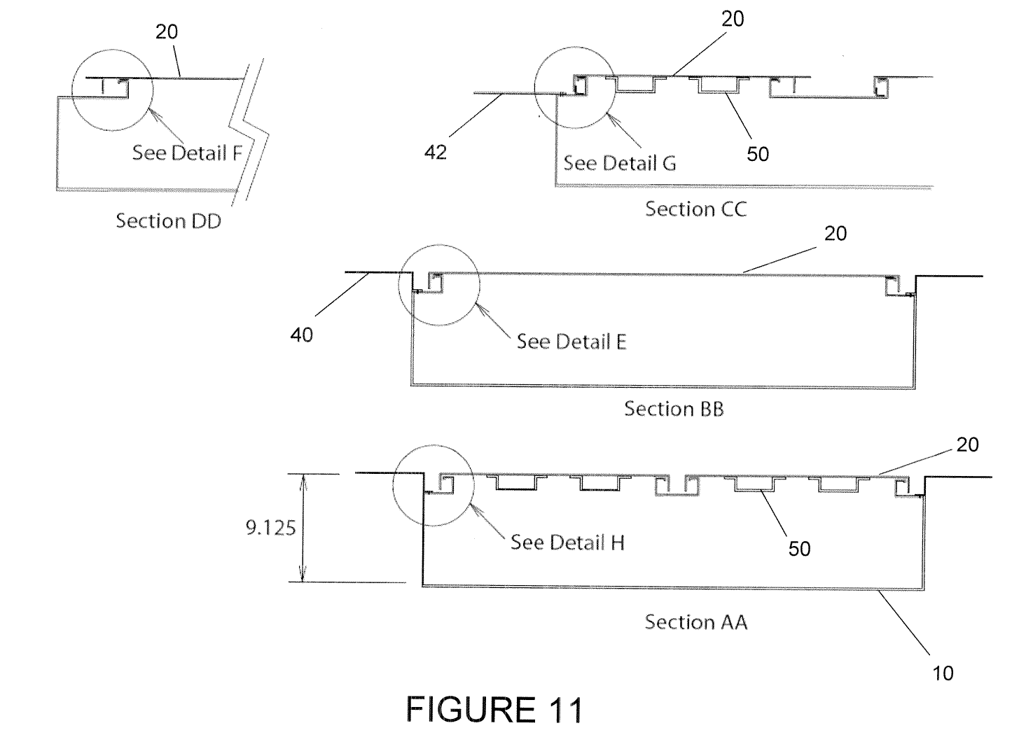

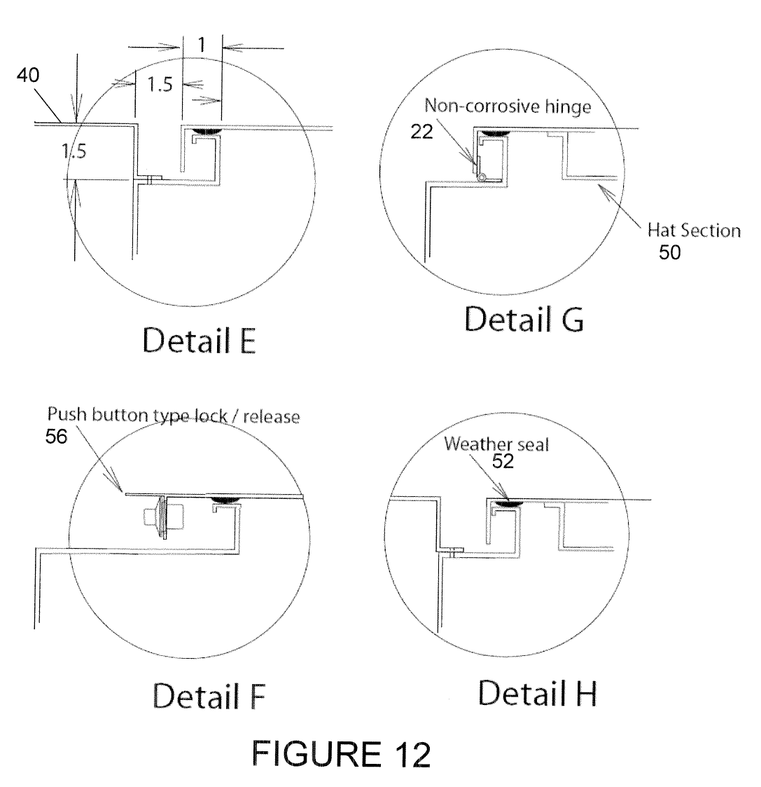

The cross-sections A-A, B-B, C-C, and DD, as indicated on FIG. 10, are shown in FIG. 11. In this embodiment, the lids 20 fit over the openings as shown. The lids may be strengthened by the use of support members or hat sections 50. Details of this embodiment of the lids are shown in FIG. 12. Weather seals 52 are used to keep water, debris, and other items from entering the box, and the hinges 22 may be located at the bottom of the end of the lid, as shown. As shown in Detail F, the locking mechanism (in this embodiment, a push-button type lock or release) may be located underneath the top of the lid and end of the lid as shown to protect the lock from damage or exposure.

In one embodiment, the box simply sits in the bed of the truck and is held in place by matching its configuration with the interior configuration of the truck bed, including the wheel wells. The weight of the box, and anything contained therein, also helps in holding the box in place. In an alternative embodiment, the box may be bolted, screwed, or similarly affixed or fastened to the truck bed on the bottom, sides, or some combination of suitable locations.

The box may be made from any suitable material that provides strength and durability. Possible construction materials include, but are not limited to, aluminum, stainless steel, regular steel, and plastic. The top of the box may be smooth, patterned, checker-plated, rough faced, or ridged. The top and other faces of the box may be coated with a material similar to a spray-on bed liner for skid proofing and protection.

In another embodiment, the box may be configured so that there is space or spaces below the box for storage of ramps, flush mount boxes, or similar items.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A box for the bed of a truck, comprising:
a container comprising a top, a bottom, a front wall, a back wall, and two side walls;
one or more lids in the top of the container providing access to the interior of the container;
wherein the bottom of the container is at least partially in contact with the bottom of the truck bed; and
further wherein the top of the container does not extend beyond the top of the truck bed.

2. The box of claim 1, further comprising one or more indentations in one or both side walls, said indentations adapted to fit around wheel wells in the truck bed.

3. The box of claim 1, wherein the bottom of the container covers approximately 50% of the truck bed area.

4. The box of claim 1, wherein the bottom of the container covers approximately 75% of the truck bed area.

5. The box of claim 1, wherein the bottom of the container covers approximately 100% of the truck bed area.

6. The box of claim 1, wherein the interior of the container is divided into two or more compartments.

7. The box of claim 6, wherein a lid provides access to two or more compartments.

8. The box of claim 6, wherein each compartment is accessed through a separate lid.

9. The box of claim 1, further comprising one or more tie-downs located on the top of the container.

10. The box of claim 1, further comprising one or more handles for each lid.

11. The box of claim 10, wherein the handles are recessed.

12. The box of claim 10, wherein the handles also act as tie-downs.

13. The box of claim 1, wherein the container is fastened to the truck bed.

14. The box of claim 13, wherein the container is bolted to the bottom of the truck bed.

15. The box of claim 1, further comprising one or more spaces under the bottom of the container and accessible through the front wall of the container.

16. The box of claim 1, further comprising one or more wings extending from the sides of the container to the sides of the truck bed.

17. The box of claim 1, further comprising at least one end cap extending from one end of the container to the nearest wall of the truck bed.
